(19) United States
(12) Patent Application Publication
(10) Pub. No.: US 2026/0227518 A1
(43) Pub. Date: Aug. 6, 2026

(54) Method and Device for Operating a Plurality of Lidar Sensors

(71) Applicant: Bayerische Motoren Werke Aktiengesellschaft, Muenchen (DE)

(72) Inventors: Jonathan FISCHER, Karlsfeld (DE); Nils WALDMANN, Muenchen (DE)

(21) Appl. No.: 19/144,994

(22) PCT Filed: Dec. 12, 2023
(86) PCT No.: PCT/EP2023/085239

§ 371 Date: Jul. 1, 2025

(30) Foreign Application Priority Data
Jan. 12, 2023 (DE) 10 2023 100 565.0

(51) Int. Cl. G01S 17/931

(52) U.S. Cl. CPC G01S 17/931

(57) ABSTRACT

A device is provided for operating a first and a second lidar sensor, each of which is configured to sequentially acquire one frame of measurement values for a plurality of different measurement points in a common acquisition region within a measurement period. The device is configured to operate the first lidar sensor with a first scanning pattern for scanning the plurality of measurement points to acquire a first frame of first measurement values for the plurality of different measurement points during the measurement period, and to operate the second lidar sensor with a second scanning pattern for scanning the plurality of measurement points to acquire a second frame of second measurement values for the plurality of different measurement points during the measurement period. The device is further configured to determine an overall frame of measurement values in the measurement period based on the first frame and the second frame.

### BACKGROUND AND SUMMARY

The invention relates to a method and a corresponding device, which are directed to enabling particularly precise acquisition of measurement data by way of one or more lidar sensors.

A vehicle controlled in an at least semiautomated manner comprises one or more surroundings sensors, which are each configured to acquire sensor data with respect to the surroundings of the vehicle. The sensor data can be evaluated to provide a driving function, by which the vehicle is longitudinally and/or laterally controlled in an at least semiautomated manner. The vehicle can in particular comprise at least one lidar sensor as a surroundings sensor in order to detect objects in the surroundings of the vehicle and/or to determine object information with respect to one or more objects in the surroundings of the vehicle.

The present document relates to the technical problem of determining reliable and precise information with respect to one or more objects in the surroundings of the lidar sensor on the basis of the sensor data from one or more lidar sensors.

The object is achieved by the claimed invention. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to one aspect, a device for operating a lidar sensor is described, which is configured to acquire a frame of measured values for a plurality of different measurement points in the acquisition area of the lidar sensor for a measurement period (having a period duration T). The lidar sensor can be designed to emit an emission signal (in particular a laser signal) in a plurality of different (acquisition) directions. The individual acquisition directions can each correspond to a measurement point. Furthermore, the individual acquisition directions can each be defined by an azimuth angle and by an elevation angle.

The lidar sensor can furthermore be configured, in reaction to the emission of an emission signal in a defined acquisition direction (i.e. to acquire a measured value for a specific measurement point), to acquire a reception signal, which is dependent on the emission signal. The reception signal can be based on a reflection of the emission signal on at least one object in the surroundings of the lidar sensor. The measured value for the defined measurement point, which corresponds to the defined acquisition direction, can indicate, for example, the intensity and/or the time-of-flight of the reception signal or can depend thereon.

The plurality of different measurement points can comprise, for example, (possibly precisely) Q measurement points, with Q>1, typically Q is equal to 100 or more, or Q is equal to 500 or more. The individual measurement points can each correspond to a combination of a defined elevation angle and a defined azimuth angle. The acquisition area of the lidar sensor can extend over a defined elevation angle range, which is divided, for example, (uniformly) into M different elevation angles. Furthermore, the acquisition area can extend over a defined azimuth angle, which is divided, for example, (uniformly) into N different azimuth angles. The number Q of measurement points can then be, for example, Q=M×N. The plurality of different measurement points can therefore correspond to Q=M×N different measurement points each having a combination of an azimuth angle having the azimuth angle index n, with n=1, . . . , N, and an elevation angle having the elevation angle index m, with m=1 . . . , M.

A frame of measured values can comprise a measured value for each individual measurement point of the plurality of measurement points. The measured values for the plurality of measurement points can be acquired sequentially within a defined measurement period, i.e. within a time interval having the period duration T.

The device is configured to determine a measured value acquired by the lidar sensor with respect to the intensity of the reception signal of the lidar sensor at the or for the respective measurement point for each of the plurality of different measurement points. As already described above, an emission signal can be emitted in the acquisition direction corresponding to the measurement point to ascertain the measured value for a measurement point. Furthermore, the reception signal based on this emission signal (which is incident on the lidar sensor from the acquisition direction) can be evaluated to ascertain the measured value for this measurement point.

The device is furthermore configured to associate the measured value with a time stamp with respect to the time at which the measured value was acquired within the measurement period by the lidar sensor. The individual measured values can therefore each be assigned a time stamp, which indicates the acquisition time within the measurement period. The measurement period can be divided here into a plurality of different acquisition times (for the corresponding plurality of different measurement points).

The individual measured values can be stored with the respectively associated time stamp in order to enable a subsequent evaluation of the frame having the measured values. The device can be configured in particular, on the basis of the measured values for the plurality of different measurement points and on the basis of the time stamps associated with the individual measured values, to ascertain object information with respect to at least one object in the acquisition area of the lidar sensor. The object information can comprise, for example, the contour of the object, a dimension (for example, the length, width, and/or height) of the object, and/or the (radial and/or tangential) velocity of the object.

The acquisition and storage of the specific acquisition times within a measurement period for the individual measurement points enables object information to be ascertained with respect to an object with increased accuracy. In particular effects such as motion blur can be reliably avoided or at least reduced in this case.

The measurement period can comprise Q partial time intervals (for the corresponding number of Q different measurement points within the frame). The device can be configured to associate each of the individual measured values with a time stamp, which indicates the partial time interval within the measurement period in which the measured value was acquired by the lidar sensor. One measurement point can be scanned in each case in each partial time interval. The period duration T of the measurement period can therefore be divided into Q partial time intervals, and the time stamp can be used to indicate the specific partial interval in which the respective measured value was acquired. The quality of the object identification can therefore be increased further on the basis of the frame of measured values of the lidar sensor.

The device can be configured to update the measured values for the Q different measurement points in each case for a sequence of successive measurement periods, and to update the time stamp for each of the individual measured values here. The update can take place such that at an arbitrary time along the sequence of measurement periods (in particular at any arbitrary partial time interval within the individual measurement periods) a frame of measured values exists in each case, which, for the individual measurement points of the plurality of measurement points, comprises the measured value which was acquired last for the respective measurement point.

A frame of measured values can therefore be provided in which individual measured values are updated quasi-continuously. The measurement periods can follow one another at a frequency of 1/T. A measured value can be updated in each case at a frequency of 1/(T*Q). The effective (average) currency of the measured values within a frame and therefore the quality of the object identification can therefore be increased by the quasi-continuous updating of individual measured values (at a frequency of 1/(T*Q)). The frame can be updated here at the frequency 1/(T*Q).

The device can be configured to identify a partial area of the acquisition area (for example, on the basis of a previously determined frame of measured values). For example, a partial area can be identified in which an object was identified (on the basis of the measured values).

Furthermore, the spatial resolution of measurement points in the identified partial area can be increased in relation to the standard resolution. Alternatively or additionally, the measuring rate (i.e. the frequency) at which measured values are acquired for one or more measurement points in the identified partial area, can be increased in relation to the standard measuring rate. The standard resolution can be, for example, D/Q, wherein D is the size of the acquisition area (wherein the size is specified, for example, as an angle range). The standard measuring rate can be 1/T. Outside the identified partial area, the spatial standard resolution and/or the standard measuring rate can be used to acquire measured values for measurement points.

A local increase of the spatial and/or chronological resolution can therefore be effectuated (in particular if a solid-state lidar sensor is used). The quality of the surroundings acquisition can thus be further increased, for example, to reduce blooming effects.

According to a further aspect, a further device for operating a lidar sensor is described. The features described in this document are also usable individually or in combination for this device. The lidar sensor is configured to acquire measured values for a plurality of different measurement points in the acquisition area of the lidar sensor. The lidar sensor can have a spatial standard resolution of measurement points (for example, D/Q) and/or the lidar sensor can have a standard measuring rate at which measured values are acquired for the individual measurement points (for example, 1/T).

The device is configured to identify a partial area of the acquisition area. The device can be configured, for example, to ascertain a frame of measured values for the plurality of different measurement points in the acquisition area for a first time (for example, for a defined first measurement period). The partial area of the acquisition area can then be identified on the basis of the frame for the first time.

The device is furthermore configured to increase the spatial resolution of measurement points in the identified partial area in relation to the standard resolution and/or to increase the measuring rate, at which measured values are acquired for one or more measurement points in the identified partial area, in relation to the standard measuring rate. The spatial resolution of measurement points and/or the measuring rate can be increased in particular for a period of time following the first time (or the first measurement period).

A locally limited increase of the chronological and/or spatial resolution of the lidar sensor can therefore be effectuated. The quality of the surroundings acquisition can thus be increased efficiently.

The device can be configured, on the basis of the frame of measured values for the first time (or for the first measurement period),
to identify an object within the acquisition area which is possibly the cause of a false positive detection in the acquisition area; and/or
to identify an object within the acquisition area which has a reflectivity that is greater than a reflectivity threshold value; and/or
to identify an object within the acquisition area which has a number of detection points of the lidar sensor which is less than a number threshold value (wherein a detection point, for example, has an intensity which is greater than a defined intensity threshold value).

The partial area of the acquisition area (in which an increase of the spatial and/or chronological resolution is effectuated) can then be ascertained in a particularly precise manner on the basis of the position of the identified object. The quality of the surroundings acquisition can thus be further increased.

The extent of the increase of the chronological and/or spatial resolution can depend on one or more properties of the object which is arranged in the identified partial area. Exemplary properties are:
the number of detection points of the object; and/or
the size (for example, the length, width, and/or height) of the object.

For example, the chronological and/or spatial resolution can be increased more the smaller the object is. The chronological and/or spatial resolution can be increased, for example, in a manner inversely proportional to the size of the object. The quality of the surroundings acquisition can be further increased by the adaptation of the extent of the increase of the chronological and/or spatial resolution depending on one or more properties of the object.

The device can be configured to ascertain, repeatedly, in particular periodically at the standard measuring rate, a frame of measured values for the plurality of different measurement points in the acquisition area. Furthermore, at least one partial area of the acquisition area can be identified on the basis of the respective frame, which, subsequently to the ascertainment of the respective frame and possibly before the ascertainment of the respectively following frame, is scanned with an increased spatial resolution and/or measuring rate. The partial area can therefore be repeatedly updated with the increased spatial and/or chronological resolution. A continuously precise surroundings acquisition can thus be effectuated.

According to a further aspect, a device for operating a first lidar sensor and a second lidar sensor is described. The features described in this document are also applicable for this device individually or in combination. The lidar sensors are each configured to sequentially acquire a frame of measured values for a plurality of different measurement points in the common acquisition area of the first and the second lidar sensor within a measurement period (having a period duration T). As already described above, Q measurement points (or corresponding acquisition directions) can each be arranged in the acquisition area.

The device is configured to operate the first lidar sensor using a first scanning pattern to scan the plurality of measurement points in order to acquire a first frame of first measured values for the plurality of different measurement points in the measurement period. Furthermore, the device is configured to operate the second lidar sensor using a second scanning pattern to scan the plurality of measurement points in order to acquire a second frame of second measured values for the plurality of different measurement points in the measurement period.

A scanning pattern can define the sequence in which the individual measurement points of the acquisition area are sequentially scanned within the measurement period (having a period duration T). All measurement points of the plurality of measurement points and/or the acquisition area can each be scanned here by the scanning pattern.

The first and second scanning pattern can be coordinated with one another and/or complementary to one another. In particular, the first scanning pattern and the second scanning pattern can each have different scanning directions for scanning the plurality of measurement points. Alternatively or additionally, the plurality of measurement points in the second scanning pattern can be scanned offset in time from the first scanning pattern.

The device can furthermore be configured to ascertain an overall frame of measured values in the measurement period on the basis of the first frame and on the basis of the second frame. The measured value for the overall frame can be ascertained here for each of the plurality of measurement points in each case from the corresponding measured value of the first frame and from the corresponding measured value of the second frame, in particular on the basis of the mean value of the measured value of the first frame and the measured value of the second frame.

A defined acquisition area can therefore be scanned by two or more lidar sensors, wherein the lidar sensors are operated using different scanning patterns, which are preferably coordinated with one another, however. The quality of the surroundings acquisition can thus be increased in a particularly efficient and reliable manner.

The device can be configured to ascertain object information with respect to at least one object in the acquisition area of the lidar sensors on the basis of the measured values from the overall frame. A particularly precise object identification can thus be effectuated.

The first scanning pattern can be designed to scan the plurality of measurement points in the opposite direction to the second scanning pattern. Particularly efficient and precise surroundings acquisition can thus be effectuated.

As already described above, the plurality of measurement points in M lines for M different elevation angles can each comprise N measurement points in N rows for N different azimuth angles. A frame can therefore comprise in each case M lines each having N rows of measurement points.

The first scanning pattern can be designed to scan the plurality of measurement points in a first scanning direction, so that the elevation angle index m is sequentially increased from 1 to M, or so that the azimuth angle index n is sequentially increased from 1 to N. On the other hand, the second scanning pattern can be designed to scan the plurality of measurement points in a second scanning direction, so that the elevation angle index m is sequentially reduced from M to 1, or so that the azimuth angle index n is sequentially reduced from N to 1. Particularly efficient and precise surroundings acquisition can be effectuated by such scanning in opposite directions.

The scanning according to the first scanning pattern can begin with the measurement point for the elevation angle index m=1 and for the azimuth angle index n=1 and can end with the measurement point for the elevation angle index m=M and for the azimuth angle index n=N. The individual measurement points can each be scanned line by line (possibly meandering) in between. The scanning according to the second scanning pattern can begin with the measurement point for the elevation angle index m=M and for the azimuth angle index n=N and end with the measurement point for the elevation angle index m=1 and for the azimuth angle index n=1. The individual measurement points can each be scanned line by line (possibly meandering) in between. Particularly efficient and precise surroundings acquisition can be effectuated by such complementary scanning.

In a further example, the first scanning pattern and the second scanning pattern can have the same scanning direction for scanning the plurality of measurement points. However, the scanning according to the second scanning pattern can be offset by a number of measurement points in relation to the scanning according to the first scanning pattern, wherein the number of measurement points is in a range Q/2±10%. Particularly efficient and precise surroundings acquisition can be effectuated by such offset scanning.

The plurality of measurement points which is scanned by the first lidar sensor can be spatially offset in relation to the plurality of measurement points which is scanned by the second lidar sensor. The spatial offset can be designed such that one measurement point from the plurality of measurement points which is scanned by the second lidar sensor is arranged in each case between directly adjacent measurement points from the plurality of measurement points which is scanned by the first lidar sensor. The measurement points of the two lidar sensors can therefore be interleaved with one another. The spatial offset between the measurement points can correspond to an offset of the elevation angle and/or the azimuth angle. The offset can correspond, for example, to half the angle distance between two directly adjacent elevation angles and/or azimuth angles.

The two or more lidar sensors can therefore be used to increase the spatial resolution of the surroundings acquisition. The quality of the surroundings acquisition can thus be further increased.

According to a further aspect, a device for operating at least one lidar sensor is described. The features described in this document are also applicable individually or in combination for this device. The lidar sensor is configured, within a measurement period, to sequentially acquire a frame of measured values for a plurality of different measurement points (for example, for M×N measurement points) in the acquisition area of the lidar sensor.

The device is configured to ascertain a scanning pattern having a pseudorandom sequence of the plurality of measurement points (in particular the M×N measurement points) on the basis of a random generator. The indices m, n can follow one another here in a pseudorandom manner, so that each possible combination (m, n), for m=1, . . . , M and n=1, . . . , N, is contained precisely once in the scanning pattern.

The lidar sensor can be operated in the measurement period using the ascertained scanning pattern to scan the plurality of measurement points in order to acquire a frame of measured values for the plurality of different measurement points in the measurement period. The quality of the surroundings acquisition can be increased by the use of a pseudorandom scanning pattern for the operation of one or more lidar sensors. Different pseudorandom scanning patterns can be ascertained and used in each case here for different lidar sensors.

A uniform (pseudorandom) scanning pattern can be used in each case on a sequence of successive measurement periods. On the other hand, the device can be configured to ascertain a measurement period-specific scanning pattern having a pseudorandom scanning sequence of the plurality of measurement points for each of a sequence of successive measurement periods on the basis of the random generator. A new pseudorandom scanning pattern can therefore be ascertained for each measurement period. Furthermore, the lidar sensor can be operated in the respective measurement period using the respectively ascertained scanning pattern to scan the plurality of measurement points. A sequence of frames of measured values can thus be acquired for the corresponding sequence of measurement periods. The quality of the surroundings acquisition can be further increased by the change of the scanning patterns.

According to a further aspect, a (road) motor vehicle (in particular a passenger vehicle or a truck or a bus or a motorcycle) is described, which comprises at least one of the devices described in this document.

According to a further aspect, a method for operating a lidar sensor is described, which is configured to acquire a frame of measured values for a plurality of different measurement points in the acquisition area of the lidar sensor for a measurement period. The method comprises, for each of the plurality of different measurement points, ascertaining in each case a measured value acquired by the lidar sensor with respect to the intensity of the reception signal of the lidar sensor for the respective measurement point (or for the corresponding acquisition direction). Furthermore, the method comprises associating the measured value with a time stamp with respect to the time at which the measured value was acquired within the measurement period by the lidar sensor.

According to a further aspect, a method for operating a lidar sensor is described, which is configured to acquire measured values for a plurality of different measurement points in the acquisition area of the lidar sensor. The lidar sensor has a spatial standard resolution of measurement points and/or a standard measuring rate at which measured values are acquired for the individual measurement points. The method comprises identifying a partial area of the acquisition area. Furthermore, the method comprises increasing the spatial resolution of measurement points in the identified partial area in relation to the standard resolution and/or increasing the measuring rate, at which measured values are acquired for one or more measurement points in the identified partial area, in relation to the standard measuring rate.

According to a further aspect, a method for operating a first lidar sensor and a second lidar sensor is described, which are each configured, within a measurement period, to acquire (by sequential scanning) a frame of measured values for a plurality of different measurement points in the common acquisition area of the first and second lidar sensor.

The method comprises operating the first lidar sensor using a first scanning pattern for (sequentially) scanning the plurality of measurement points, in order to acquire a first frame of first measured values for the plurality of different measurement points in the measurement period, and operating the second lidar sensor using a second scanning pattern for (sequentially) scanning the plurality of measurement points, in order to acquire a second frame of second measured values for the plurality of different measurement points in the measurement period.

The first scanning pattern and the second scanning pattern can each have different scanning directions for scanning the plurality of measurement points. Alternatively or additionally, the plurality of measurement points in the second scanning pattern can be scanned offset in time in relation to the first scanning pattern. The method can furthermore comprise ascertaining an overall frame of measured values in the measurement period on the basis of the first frame and on the basis of the second frame.

According to a further operation, a further method for operating a lidar sensor is described, which is configured, within a measurement period, to sequentially acquire a frame of measured values for a plurality of different measurement points in the acquisition area of the lidar sensor. The method comprises ascertaining, on the basis of a random generator, a scanning pattern having a pseudorandom sequence of the plurality of measurement points. Furthermore, the method comprises operating the lidar sensor in the measurement period using the ascertained scanning pattern for scanning the plurality of measurement points in order to acquire a frame of measured values for the plurality of different measurement points in the measurement period. The frame of measured values can be used for object identification and/or for the operation of a driving function of a vehicle.

According to a further aspect, a software (SW) program is described. The SW program can be configured to be executed on a processor (for example, on a control unit of a vehicle), and to thus carry out at least one of the methods described in this document.

According to a further aspect, a storage medium is described. The storage medium can comprise an SW program which is configured to be executed on a processor, and to thus carry out at least one of the methods described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The invention is described in more detail hereinafter on the basis of exemplary embodiments.

### BRIEF DESCRIPTION OF THE DRAWINGS

FIG. 1a shows an exemplary vehicle having one or more lidar sensors.

FIG. 1b shows an exemplary frame of measured values of a lidar sensor.

FIG. 2 shows a flow chart of an exemplary method for acquiring measured values of a lidar sensor for a plurality of different measurement points within the acquisition area of the lidar sensor.

FIG. 3 shows a flow chart of an exemplary method for acquiring measured values of a lidar sensor for one or more measurement points within the acquisition area of the lidar sensor.

FIGS. 4a and 4b show exemplary scanning patterns for scanning the acquisition area of a lidar sensor.

FIG. 5 shows a flow chart of an exemplary method for acquiring measured values of multiple lidar sensors having a common acquisition area.

### DETAILED DESCRIPTION OF THE DRAWINGS

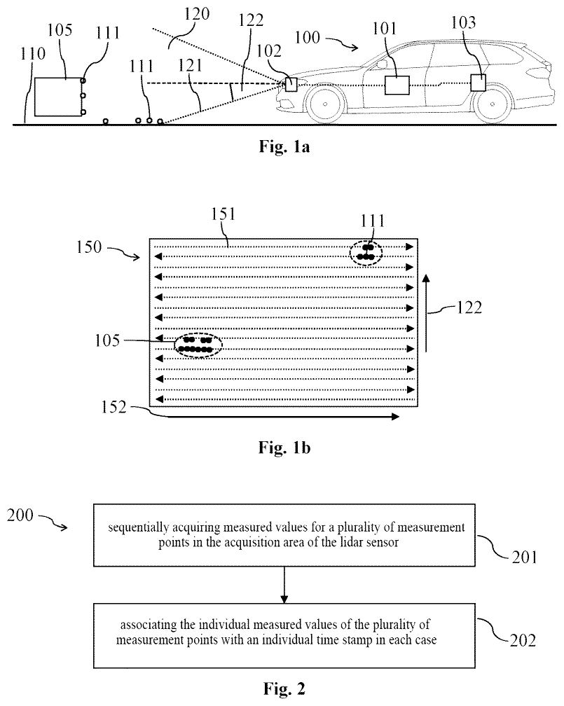

As described at the outset, the present document relates to the precise acquisition of the surroundings of a (motor) vehicle by way of at least one lidar sensor. In this context, FIG. 1a shows an exemplary vehicle 100, which has at least one lidar sensor 102 configured to acquire sensor data with respect to the surroundings of the vehicle 100, in particular with respect to the surroundings in front of the front of the vehicle 100. The lidar sensor 102 can be configured to emit an emission signal (for example, a laser signal), and to receive a reception signal dependent on the emission signal. The reception signal can be based on a reflection of the emission signal on an object 105 in the surroundings of the vehicle 100.

The lidar sensor 102 can have a defined acquisition area 120, wherein the acquisition area 120 has a plurality of different acquisition directions 121. The plurality of different acquisition directions 121 can be defined in polar coordinates of a polar coordinate system, wherein the lidar sensor 102 is arranged in the origin point of the polar coordinate system. The different acquisition directions 121 can have azimuth angles in a defined azimuth angle range. Furthermore, the different acquisition directions 121 can have elevation angles in a defined elevation angle range. The acquisition area 120 of the lidar sensor 102 can therefore be defined by the combination of azimuth angle range and elevation angle range. Furthermore, a limit of the acquisition area with respect to the maximum possible radial distance of detections can exist. Furthermore, the lidar sensor 102 can have a defined angle resolution with respect to possible azimuth angles and/or with respect to possible elevation angles.

FIG. 1a shows a reception direction 121 having a defined elevation angle 122 by way of example. In general, a reception direction 121 can have a defined azimuth and/or elevation angle.

The lidar sensor 102 can be configured to acquire a detection point 111 in a defined acquisition direction 121 (i.e. for a defined azimuth angle and for a defined elevation angle 122) on the basis of the emission signal when the emission signal has been reflected from an object 105 or from the ground 110 on which the vehicle 100 is traveling. On the other hand, no detection point 111 is typically acquired by the lidar sensor 102 if the emission signal is not reflected or is not reflected sufficiently strongly. Therefore, a cloud of detection points 111 can be provided by the lidar sensor 102 for the acquisition area 120 of the lidar sensor 102, by which one or more objects 105 and possibly the ground 110 in the surroundings of the vehicle 100 are indicated.

A (control) device 101 of the vehicle 100 can be configured to evaluate the sensor data, in particular the cloud of detection points 111, of the lidar sensor 102, for example, to create a surroundings model with respect to the surroundings of the vehicle 100. The device 101 can be configured in particular to provide one or more driving functions on the basis of the sensor data of the lidar sensor 102 (in particular on the basis of a frame of measured values of the lidar sensor 102), by which the vehicle 100 is longitudinally and/or laterally controlled in an at least semiautomated or completely automated manner. For this purpose, one or more longitudinal and/or lateral control actuators 103 (such as a drive motor, a braking device, and/or a steering device) of the vehicle 100 can be actuated.

FIG. 1b shows an exemplary frame 150 of measured values for a plurality of measurement points 151 within the acquisition area 120 of the lidar sensor 102. A measurement point 151 corresponds to an acquisition direction 121 having a defined value of the elevation angle 122 and a defined value of the azimuth angle 152. The lidar sensor 102 can be designed to sequentially ascertain measured values for all possible measurement points 151 (i.e. for all possible acquisition directions 121) within the acquisition area 120. A defined scanning pattern can be used here in order to sequentially scan the different measurement points 151 within the acquisition area 120. For example, the scanning of the acquisition area 120, as shown by way of example in FIG. 1b, can be begun at the top left. Measurement points 151 can then be scanned line by line (for example, meandering), until the scan of the acquisition area 120 is ended at the bottom right.

As already described above, the acquisition area 120 can be defined by an azimuth angle range (which extends, for example, from a first azimuth angle to a second azimuth angle) and by an elevation angle range (which extends, for example, from a first elevation angle to a second elevation angle). The azimuth angle range can be divided (possibly uniformly) into N (for example, N equal to 10 or more, or 50 or more, or 100 or more) different azimuth angles and the elevation angle range can be divided (possibly uniformly) into M (for example, M equal to 10 or more, or 50 or more, or 100 or more) different elevation angles. The acquisition area 120 can therefore be divided into (precisely) M×N different acquisition directions 121 or measurement points 151.

The scanning pattern shown in FIG. 1b can begin at the measurement point (1, 1). Subsequently, the measurement points 151 of the first line m=1 can be acquired, from n=1 to n=N. Subsequently, the measurement points of the following line m=2 can be acquired in the reverse direction, from n=N to n=1. The lines m=3 to m=M can then be scanned sequentially, each in alternating direction, so that a meandering scan is effectuated until finally the measurement point (M, N) is scanned.

The scanning pattern for scanning the acquisition area 120 can be scanned within a defined time interval (i.e. within a defined measurement period) having a defined period duration T (for example, T equal to 100 ms or less, or 50 ms or less), so that frames 150 of the lidar sensor 102 can be provided at a frequency of f=1/T, wherein each frame 150 comprises measured values for the M×N measurement points 151 of the acquisition area 120. The individual frames 150 k=0, . . . , K can each be associated with a defined time tₖ, wherein the times tₖ can be ascertained recursively starting from a specific initial time t₀, tₖ₊₁=tₖ+T. The measured values of the individual measurement points 151 can each indicate:
the intensity and/or the energy of the acquisition signal;
the phase of the acquisition signal relative to the emission signal; and/or
the time delay of the acquisition signal relative to the emission signal.

Individual detection points 111 can be identified on the basis of the individual measured values for the plurality of measurement points 151. For example, it can be determined that a detection point 111 is located at a defined measurement point 151 if the measured value for the defined measurement point 151 has an intensity which is greater than a defined intensity threshold value.

Individual detection points 111 can therefore be identified within a frame 150. One or more objects 105 in the surroundings of the lidar sensor 102 can be detected on the basis of the detection points 111, for example, using a clustering algorithm.

The sequential acquisition of frames 150 of measurement points 151 within measurement periods having a respective period duration T can result in a fuzziness in the identification of objects 105, in particular if the object 105 and/or the lidar sensor 102 move during the individual measurement periods. This effect can be referred to as “motion blur”. Furthermore, a rolling shutter effect can occur as a result of the sequential scanning of the acquisition area 120.

In particular if a solid-state lidar sensor 120 having a phase shifter-based beam deflection is used, it is possible to deviate from the scanning pattern shown in FIG. 1b for scanning the acquisition area 120 of the lidar sensor 120. The beam deflection technology enables the direction of a (light-based) emission signal, and therefore the acquisition direction 121, to be changed in an arbitrary manner. This enables the different measurement points 151 of a frame 150 to be scanned in an arbitrary, possibly pseudorandom, sequence. In other words, it is possible to cause the M×N measurement points 151 of the acquisition area 120 to be scanned within a period having the period duration T in a (pseudo)random manner. The above-mentioned effects can thus at least be reduced.

Alternatively or additionally, it is possible to cause each measurement point 151 of the acquisition area 120 to be read out directly after its acquisition and associated with the respectively associated time stamp. The following can therefore be determined for each of the individual measurement points 151:
a measured value; and
a time stamp, which indicates the time (within the respective measurement period) at which the measured value was acquired.

The time stamp for the measured value of a measurement point 151 can indicate a time t_{k,q}, wherein k=0, . . . , K indicates the measurement period and/or the frame 150, in which the measured value was ascertained, and wherein q=1, . . . , Q indicates a time index or a partial time interval within the respective measurement period and/or within the respective frame 150, wherein preferably Q=M×N. The time interval of a frame 150 can therefore be divided uniformly into Q partial time intervals, wherein one measured value for a measurement point 151 is acquired in each partial interval. The time stamp for the measured value of a measurement point 151 can therefore indicate the partial interval within a frame 150 or within a measurement period, in which the respective measured value was acquired.

Due to the assignment of time stamps to the individual measured values, the chronological resolution can therefore be increased by the factor Q, so that updated measured values for the different measurement points 151 of the acquisition area 120 can be provided quasi-continuously. In particular, a continuously updated point cloud (having detection points 111) can be provided. In other words, the dead time between successive frames 150 can be avoided, and it is possible to cause the point cloud acquired by the lidar sensor 102 to be (quasi-)continuously updated.

The time stamps of the individual measured values can be taken into consideration in the evaluation of the measured values (in particular the point cloud). The motion blur effect and/or the rolling shutter effect can thus be reduced or avoided in an efficient and reliable manner.

FIG. 2 shows a flow chart of a (possibly computer-implemented) method 200 for operating a lidar sensor 102. The lidar sensor 102 is configured, for a measurement period having a period duration T, to acquire a frame 150 of measured values for a plurality of different measurement points 151, in particular for M×N measurement points 151, in the acquisition area 120 of the lidar sensor 102. The measured values can be acquired sequentially within the measurement period, so that the measured value for the first measurement point 151 is acquired at the beginning of the measurement period and the measured value for the last measurement point 151 is acquired at the end of the measurement period. The duration between the beginning and the end of the measurement period corresponds to the period duration T.

The method 200 comprises (in a sequential manner), for each of the plurality of different measurement points 151, in each case ascertaining 201 the measured value acquired by the lidar sensor 102 with respect to the intensity of the reception signal of the lidar sensor 102 at the respective measurement point 151.

Furthermore, the method 200 comprises associating 202 the measured value with a time stamp with respect to the time at which the measured value was acquired within the measurement period by the lidar sensor 102. The time can in particular indicate a time which lies between the starting time and the end time of the measurement period.

As already described, the device 101 can be configured to detect at least one object 105 on the basis of the measured values of the lidar sensor 102. In this case, the partial area of the acquisition area 120 can be ascertained in which the object 105 is arranged. Furthermore, it is possible to cause measured values to be acquired for measurement points 151 in the ascertained partial area, for example,
with an increased scanning rate (in comparison to the standard scanning rate f=1/T); and/or
with an increased spatial resolution (in comparison to the standard spatial resolution of D/(M×N)). In this case, D indicates the size of the acquisition area 120, wherein the size is defined, for example, by an angle range.

A focus area of the acquisition area 120 can therefore be ascertained, in which measurement points 151 are scanned with increased frequency and/or with increased spatial resolution. The quality of the surroundings acquisition can thus be further increased. For example, the (radial and/or tangential) velocity of an object 105 can be ascertained by evaluating time and/or position differences.

False positive (FP) detections can occur due to multipath propagation. An FP detection can be caused, for example, in that the emission signal of the lidar sensor 102 emitted in a defined acquisition direction 121 is reflected on an intermediate object 105 and deflected on an aggressor object 105, from which the emission signal is then reflected as the reception signal back to the lidar sensor 102. This multipath propagation of the emission signal results in an extended time-of-flight of the emission/reception signal, so that for the defined acquisition direction 121, a detection point 111 is identified (as the FP detection), which has a relatively long distance from the lidar sensor 102 (and which is arranged behind the intermediate object 105).

A partial area around the defined acquisition direction 121 and/or a partial area around the position of the aggressor object 105 can each be defined as a focus area for which more detailed scanning takes place. An FP detection can thus be identified with increased accuracy and/or reliability.

In a further example, for example, a relatively small object 105 (possibly having a relatively long distance and/or having relatively few detection points 111) can have been identified. Such an object 105 can be an FP detection (for example, due to a blooming effect or due to an inadequate spatial resolution). A partial area around the identified object 105 can be defined as a focus area, and can be scanned with increased chronological and/or spatial resolution. It can thus be decided with increased reliability and accuracy whether it is an actual object 105 or an FP detection.

The blooming effect can occur in particular with a retroreflector. A further object 105 in direct proximity to the retroreflector possibly may not be identified due to the blooming effect. A focus area can be defined around the partial area of the blooming effect to check with increased accuracy and/or reliability whether a further object 105 (having a relatively low reflectivity) is located in the vicinity of the retroreflector or not.

The device 101 can be configured to adapt the (chronological and/or spatial) resolution in the partial area of an object 105 depending on the size of the object 105. For example, the (chronological and/or spatial) resolution can be reduced with increasing size and/or increased with decreasing size.

For example, using a relatively low (chronological and/or spatial) standard resolution, scanning of the entire acquisition area 120 of the lidar sensor 102 can be effectuated (for example, at a frequency of 100 Hz), in order to ascertain a complete frame 150 of measured values in each case. One or more partial areas can be identified based on the complete frame 150 (for example, in the surroundings of a cluster of detection points 111 in each case). The individual partial areas can then be scanned using a relatively high (chronological and/or spatial) resolution (for example, at a frequency of 15 Hz). The quality of the surroundings acquisition can thus be increased in an efficient manner.

FIG. 3 shows a flow chart of a (possibly computer-implemented) method 300 for operating a lidar sensor 102, which is configured to acquire measured values for a plurality of different measurement points 151, in particular for M×N measurement points 151, in the acquisition area 120 of the lidar sensor 102. The lidar sensor 102 can have a standard spatial resolution of measurement points 151, which is defined, for example, by the uniform division of the azimuth angle range into N azimuth angles and by the uniform division of the elevation angle range into M elevation angles. Alternatively or additionally, the lidar sensor 102 can have a standard measuring rate, using which measured values are acquired for the individual measurement points 151. The standard measuring rate can be, for example, f=1/T, wherein T is the period duration of a measurement period.

The method 300 comprises identifying 301 a partial area (i.e. a focus area) of the acquisition area 120. The partial area can be identified, for example, on the basis of a previously acquired frame 150 of measured values.

Furthermore, the method 300 comprises increasing 302 the spatial resolution of measurement points 151 in the identified partial area in relation to the standard resolution and/or the measuring rate using which measured values are acquired for one or more measurement points 151 in the identified partial area in relation to the standard measuring rate. A selective increase of the chronological and/or spatial resolution of the lidar sensor 102 can therefore be effectuated in a partial area of the acquisition area 120.

As already described above, the relatively long duration T of the period for acquiring a frame 150 of measured values can result in smearing of moving objects 105 (i.e. motion blur). As a result, such objects 105 possibly may not be sharply acquired. This can result in errors in the ascertainment of object sizes, in the ascertainment of object positions, and/or in the delimitation from adjacent objects 105.

The motion blur effect can be at least partially or completely compensated for by providing time stamps for the measured values of the individual measurement points 151. If an FMCW (frequency modulated continuous wave) lidar sensor 102 is used, the measured values can each indicate the velocity of the respective measurement point 151, so that a particularly precise correction of the motion blur effect is possible based on this information in combination with the time stamp.

Alternatively or additionally, multiple lidar sensors 102 can be used, in order to scan measurement points 151 in a defined (uniform) acquisition area 120. The scanning patterns for scanning the acquisition area 120 can be coordinated with one another. The motion blur effect can thus be compensated in a particularly reliable manner.

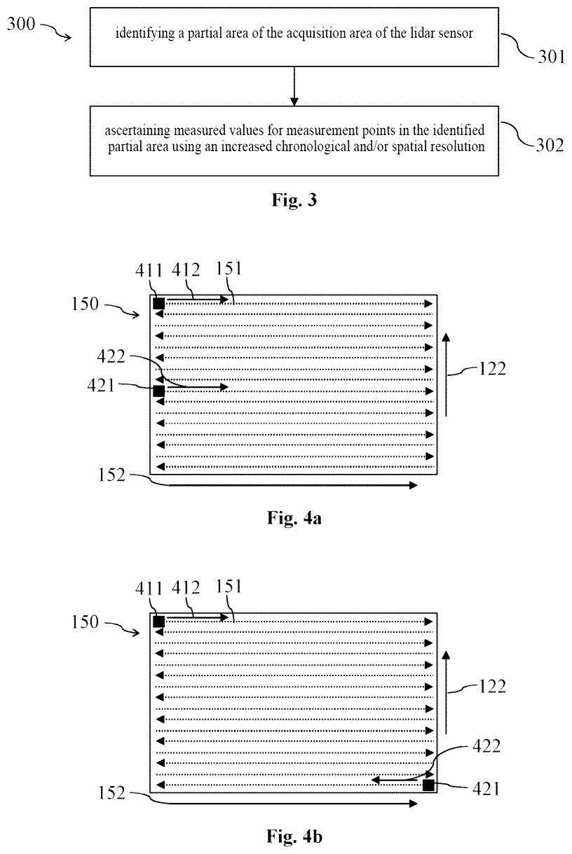

FIGS. 4a and 4b show different scanning patterns, which are coordinated with one another, of a first lidar sensor 102 and a second lidar sensor 102. The first scanning pattern of the first lidar sensor 102 can begin at a first starting measurement point 411 and the further measurement points 151 can be scanned along a first scanning direction 412 starting from the first starting measurement point 411 (possibly meandering). In a corresponding manner, the second scanning pattern of the second lidar sensor 102 can begin at a second starting measurement point 421 and the measurement points 151 can be scanned along a second scanning direction 422.

FIG. 4a shows an example in which the first scanning pattern and the second scanning pattern have the same scanning direction 412, 422. The second starting measurement point 421 of the second scanning pattern is offset in relation to the first starting measurement point 411 of the first scanning pattern, for example, by (M×N)/2 measurement points 151.

FIG. 4b shows an example in which the two scanning patterns have opposite scanning directions 412, 422 (the scanning patterns can therefore be in opposite directions to one another). Furthermore, the first measurement point (1, 1) of the frame 150 is selected as the first starting measurement point 411 for the first scanning pattern and the last measurement point (M, N) of the frame 150 is selected as the second starting measurement point 412 for the second scanning pattern.

Due to the use of different scanning patterns, having different scanning directions 412, 422 and/or having a time offset in relation to one another, it is possible to cause two measured values to be provided for each measurement point 151 in each case within the period duration T for scanning a frame 150, which measured values were each acquired offset in time in relation to one another (for example, offset in time by T/2 in each case). A motion blur effect can thus be reduced in a reliable manner.

A first and a second lidar sensor 102 can therefore be used, wherein the second lidar sensor 102 guides its laser beam along a mirrored scamming pattern (relative to the scanning pattern of the first lidar sensor 102). The second scanning pattern can be offset at an angle in relation to the first scanning pattern, by which the spatial resolution can be increased. In other words, the measurement points 151 of the first scanning pattern and the measurement points 151 of the second scanning pattern can be spatially offset in relation to one another.

By the use of multiple lidar sensors 102 having scanning patterns which are coordinated with one another, the spatial resolution and/or the speed for acquiring a frame 150 can be increased.

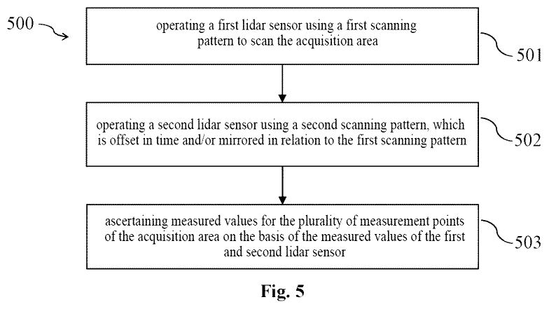

FIG. 5 shows a flow chart of a (possibly computer-implemented) method 500 for operating a first lidar sensor 102 and a second lidar sensor 102, which are each configured, within a measurement period, to sequentially acquire a frame 150 of measured values for a plurality of different measurement points 151, in particular for M×N measurement points 151, in a common acquisition area 120 of the first and the second lidar sensor 102.

The method 500 comprises operating 501 the first lidar sensor 102 using a first scanning pattern to scan the plurality of measurement points 151, in order to acquire a first frame 150 of first measured values for the plurality of different measurement points 151 in the measurement period. Furthermore, the method 500 comprises operating 502 the second lidar sensor 102 using a second scanning pattern to scan the plurality of measurement points 151, in order to acquire a second frame 150 of second measured values for the plurality of different measurement points 151 in the measurement period.

The first scanning pattern and the second scanning pattern can each have different scanning directions 412, 422 for scanning the plurality of measurement points 151. Alternatively or additionally, the plurality of measurement points 151 in the second scanning pattern can be scanned offset in time in relation to the first scanning pattern.

The method 500 furthermore comprises ascertaining 503 an overall frame 150 of measured values in the measurement period on the basis of the first frame 150 and on the basis of the second frame 150.

The present invention is not restricted to the exemplary embodiments shown. In particular, it is to be noted that the description and the figures are only to illustrate the principle of the proposed methods, devices, and systems by way of example.

1.-12. (canceled)

13. A device for operating a first lidar sensor and a second lidar sensor, which are each configured, within a measurement period, to sequentially acquire a frame of measured values for a plurality of different measurement points in a common acquisition area of the first lidar sensor and the second lidar sensor; wherein the device is configured:
to operate the first lidar sensor using a first scanning pattern to scan the plurality of measurement points, in order to acquire a first frame of first measured values for the plurality of different measurement points in the measurement period;
to operate the second lidar sensor using a second scamming pattern to scan the plurality of measurement points, in order to acquire a second frame of second measured values for the plurality of different measurement points in the measurement period; wherein:
the first scanning pattern and the second scanning pattern each have different scanning directions for scanning the plurality of measurement points; and/or
the plurality of measurement points in the second scanning pattern is scanned offset in time in relation to the first scanning pattern; and
to ascertain an overall frame of measured values in the measurement period based on the first frame and based on the second frame.

14. The device according to claim 13, wherein the first scamming pattern scans the plurality of measurement points in a direction opposite to the second scanning pattern.

15. The device according to claim 13, wherein:
the plurality of measurement points in M lines for M different elevation angles each have N measurement points in N rows for N different azimuth angles;
the first scanning pattern scans the plurality of measurement points in a first scanning direction, so that:
an elevation angle index m is sequentially increased from 1 to M; or
an azimuth angle index n is sequentially increased from 1 to N; and
the second scanning pattern scans the plurality of measurement points in a second scanning direction, so that:
the elevation angle index m is sequentially reduced from M to 1; or
the azimuth angle index n is sequentially reduced from N to 1.

16. The device according to claim 15, wherein
the first scanning pattern begins with a measurement point for an elevation angle index m=1 and for an azimuth angle index n=1 and ends with a measurement point for an elevation angle index m=M and for an azimuth angle index n=N; and
the second scanning pattern begins with the measurement point for the elevation angle index m=M and for the azinmth angle index n=N and ends with the measurement point for the elevation angle index m=1 and for the azimuth angle index n=1.

17. The device according to claim 13, wherein:
the first scanning pattern and the second scanning pattern have a same scanning direction for scanning the plurality of measurement points;
the plurality of measurement points has Q measurement points, which are scanned sequentially within the measurement period; and
the second scanning pattern is offset in relation to the first scanning pattern by a number of measurement points which is in a range Q/2±10%.

18. The device according to claim 13, wherein the device is further configured, for each of the plurality of measurement points, to ascertain a measured value for the overall frame from a measured value of the first frame and a measured value of the second frame.

19. The device according to claim 18, wherein the device is further configured, for each of the plurality of measurement points, to ascertain the measured value for the overall frame based on a mean value of the measured value of the first frame and the measured value of the second frame.

20. The device according to claim 13, wherein:
the plurality of measurement points which is scanned by the first lidar sensor is spatially offset in relation to the plurality of measurement points which is scanned by the second lidar sensor, such that in each case one measurement point from the plurality of measurement points which is scanned by the second lidar sensor is arranged between directly adjacent measurement points from the plurality of measurement points which is scanned by the first lidar sensor; and
the spatial offset between the measurement points in particular corresponds to an offset of an elevation angle and/or an azimuth angle.

21. The device according to claim 13, wherein:
the device is further configured to ascertain, based on the measured values from the overall frame, object information with respect to at least one object in the acquisition area of the first lidar sensor and the second lidar sensor; and
the object information comprises:
a contour of the object;
a dimension of the object; and/or
a velocity of the object.

22. A device for operating a lidar sensor, which is configured, within a measurement period, to sequentially acquire a frame of measured values for a plurality of different measurement points in an acquisition area of the lidar sensor; wherein the device is configured:
to determine a scanning pattern having a pseudorandom sequence of the plurality of measurement points by way of a random generator; and
to operate the lidar sensor in the measurement period using the ascertained scanning pattern to scan the plurality of measurement points, in order to acquire a frame of measured values for the plurality of different measurement points in the measurement period.

23. The device according to claim 22, wherein the device is further configured, for each of a sequence of successive measurement periods:
to ascertain a measurement period-specific scanning pattern having a pseudorandom sequence of the plurality of measurement points by way of the random generator; and
to operate the lidar sensor in a respective measurement period using a respectively ascertained scanning pattern to scan the plurality of measurement points,
in order to acquire a sequence of frames of measured values for a corresponding sequence of measurement periods.

24. A method for operating a first lidar sensor and a second lidar sensor, which are each configured, within a measurement period, to sequentially acquire a frame of measured values for a plurality of different measurement points in a common acquisition area of the first lidar sensor and the second lidar sensor, the method comprising:
operating the first lidar sensor using a first scanning pattern to scan the plurality of measurement points, in order to acquire a first frame of first measured values for the plurality of different measurement points in the measurement period;
operating the second lidar sensor using a second scanning pattern to scan the plurality of measurement points, in order to acquire a second frame of second measured values for the plurality of different measurement points in the measurement period; wherein:
the first scanning pattern and the second scanning pattern each have different scanning directions for scanning the plurality of measurement points; and/or
the plurality of measurement points in the second scanning pattern is scanned offset in time in relation to the first scanning pattern; and
ascertaining an overall frame of measured values in the measurement period based on the first frame and based on the second frame.

25. A method for operating a lidar sensor, which is configured, within a measurement period, to sequentially acquire a frame of measured values for a plurality of different measurement points in an acquisition area of the lidar sensor, the method comprising:
ascertaining, by way of a random generator, a scanning pattern having a pseudorandom sequence of the plurality of measurement points; and
operating the lidar sensor in the measurement period using the ascertained scanning pattern to scan the plurality of measurement points, in order to acquire a frame of measured values for the plurality of different measurement points in the measurement period.
